(19) United States
(12) Patent Application Publication
(10) Pub. No.: US 2019/0181705 A1
(43) Pub. Date: Jun. 13, 2019

(54) ROTOR AND METHOD FOR DESIGNING ROTOR

(71) Applicant: AISIN AW CO., LTD., Anjo-shi, Aichi-ken (JP)

(72) Inventors: Junichi YOKOTA, Nagoya (JP); Takahiro ODAGI, Okazaki (JP)

(73) Assignee: AISIN AW CO., LTD., Anjo-shi, Aichi-ken (JP)

(21) Appl. No.: 16/081,231

(22) PCT Filed: Mar. 31, 2017
(86) PCT No.: PCT/JP2017/013703

§ 371 Date: Aug. 30, 2018

(30) Foreign Application Priority Data
Mar. 31, 2016 (JP) 2016-073005

(51) Int. Cl. H02K 1/27; H02K 1/16; H02K 21/14

(52) U.S. Cl. CPC H02K 1/2766; H02K 21/14; H02K 1/16

(57) ABSTRACT

A rotor for an inner rotor rotating electrical machine, wherein the rotor core includes a first hole formed on the outer side in the radial direction with respect to the first magnetic pole surface at a position where the first hole overlaps, as viewed in the radial direction, a first end region including an end of the first magnetic pole surface on the first circumferential side, and a second hole formed on the outer side in the radial direction with respect to the second magnetic pole surface at a position where the second hole overlaps, as viewed in the radial direction, a second end region including an end of the second magnetic pole surface on the second circumferential side.

### BACKGROUND

The present disclosure relates to a rotor for an inner rotor type rotating electrical machine, including a rotor core and permanent magnets embedded in the rotor core, and to a method for designing the rotor.

A rotor described in Japanese Patent Application Publication No. 2006-254629 (JP 2006-254629A) is known as the rotor described above. JP 2006-254629A discloses a rotor in which a pair of permanent magnets that structure one magnetic pole are arranged in a V-shape so that the distance between the pair of permanent magnets increases toward an outer side in a radial direction. In this structure, a reluctance torque generated by magnetic saliency (Ld<Lq) between a q-axis inductance (Lq) and a d-axis inductance (Ld) can be used in addition to a magnet torque generated by flux linkage (coil flux linkage) due to the permanent magnets. JP 2006-254629 A describes a technology for setting an open angle between the pair of permanent magnets so that the harmonic content in a magnetic flux waveform is a low value in order to reduce harmonic components of iron loss.

When the rotor embedded with the permanent magnets rotates, a counter-electromotive voltage (induced voltage) is generated on a coil of a stator due to the flux linkage from the permanent magnets. The counter-electromotive voltage increases as the rotation speed of the rotor increases. It is necessary that the peaks of the counter-electromotive voltage in a non-energized state do not exceed a withstand voltage of an element provided in a power supply-side device (such as an inverter device). The fundamental component of the counter-electromotive voltage has a relationship with the magnet torque, and it is therefore desirable that the peaks of the counter-electromotive voltage be reduced by reducing harmonic components of the counter-electromotive voltage. In this respect, the counter-electromotive voltage corresponds to a time derivative of the flux linkage, and therefore the harmonic components of the counter-electromotive voltage can be reduced by reducing the harmonic content in the magnetic flux waveform through the use of the technology described in JP 2006-254629 A. In the technology described in JP 2006-254629 A, however, the output torque of the rotating electrical machine is not appropriately taken into consideration when the open angle between the pair of permanent magnets is derived. Thus, the output torque of the rotating electrical machine may decrease.

### SUMMARY

Therefore, there is a demand to attain a rotor in Which the peaks of a counter-electromotive voltage that may be generated on a stator coil can be reduced while increasing a torque of a rotating electrical machine and a method for designing the rotor.

In view of the above, a rotor for an inner rotor type rotating electrical machine, including a rotor core and permanent magnets embedded in the rotor core, has the following features in its structure. Magnetic poles are each formed by a pair of the permanent magnets arranged side by side in a circumferential direction. Of the pair of the permanent magnets that form one of the magnetic poles, the permanent magnet arranged on a first circumferential side that is one side in the circumferential direction is defined as a first permanent magnet, and the permanent magnet arranged on a second circumferential side that is the other side in the circumferential direction is defined as a second permanent magnet. A first magnetic pole surface that is a magnetic pole surface of the first permanent magnet that is oriented toward an outer side in a radial direction is arranged so that a portion of the first magnetic pole surface that is closer to the first circumferential side is located further outward in the radial direction. A second magnetic pole surface that is a magnetic pole surface of the second permanent magnet that is oriented toward the outer side in the radial direction is arranged so that a portion of the second magnetic pole surface that is closer to the second circumferential side is located further outward in the radial direction. The rotor core includes a first hole formed on the outer side in the radial direction with respect to the first magnetic pole surface at a position where the first hole overlaps, as viewed in the radial direction, a first end region including an end of the first magnetic pole surface on the first circumferential side, and a second hole formed on the outer side in the radial direction with respect to the second magnetic pole surface at a position where the second hole overlaps, as viewed in the radial direction, a second end region including an end of the second magnetic pole surface on the second circumferential side.

According to the features in the structure described above, the first hole and the second hole limit ranges in which coil flux linkage occurs on the first magnetic pole surface and the second magnetic pole surface while improving a reluctance torque (improving the usage of the reluctance torque) by appropriately setting ranges in the circumferential direction in which the first magnetic pole surface and the second magnetic pole surface are arranged. Therefore, a harmonic component of the counter-electromotive voltage generated on the stator coil can be reduced by adjusting a harmonic component of the coil flux linkage due to rotation of the rotor. Thus, the peaks of the counter-electromotive voltage that may be generated on the stator coil can be reduced while increasing the torque of the rotating electrical machine.

In view of the above, a method for designing a rotor for an inner rotor type rotating electrical machine, including a rotor core and permanent magnets embedded in the rotor core, has the following features in its structure. Magnetic poles are each formed by a pair of the permanent magnets arranged side by side in a circumferential direction. Of the pair of the permanent magnets that form one of the magnetic poles, the permanent magnet arranged on a first circumferential side that is one side in the circumferential direction is defined as a first permanent magnet, and the permanent magnet arranged on a second circumferential side that is the other side in the circumferential direction is defined as a second permanent magnet. The method includes arranging first magnetic pole surface that is a magnetic pole surface of the first permanent magnet that is oriented toward an outer side in a radial direction so that a portion of the first magnetic pole surface that is closer to the first circumferential side is located further outward in the radial direction, and arranging a second magnetic pole surface that is a magnetic pole surface of the second permanent magnet that is oriented toward the outer side in the radial direction so that a portion of the second magnetic pole surface that is closer to the second circumferential side is located further outward in the radial direction. The rotor core includes a first hole formed on the outer side in the radial direction with respect to the first magnetic pole surface at a position where the first hole overlaps, as viewed in the radial direction, a first end region including an end of the first magnetic pole surface on the first circumferential side, and a second hole formed on the outer side in the radial direction with respect to the second magnetic pole surface at a position where the second hole overlaps, as viewed in the radial direction, a second end region including an end of the second magnetic pole surface on the second circumferential side. The first hole and the second hole are formed so that harmonic components of a plurality of target orders on a fundamental component of a counter-electromotive voltage generated by rotation of the rotor on a coil of a stator arranged so as to face an outer peripheral surface of the rotor core are reduced as compared to a case where the first hole and the second hole are not provided.

According to the features in the structure described above, the first hole and the second hole limit the ranges in which the coil flux linkage occurs on the first magnetic pole surface and the second magnetic pole surface while improving the reluctance torque (improving the usage of the reluctance torque) by appropriately setting the ranges in the circumferential direction in which the first magnetic pole surface and the second magnetic pole surface are arranged. Therefore, the harmonic component of the counter-electromotive voltage generated on the stator coil can be reduced by adjusting the harmonic component of the coil flux linkage due to the rotation of the rotor. Thus, it is possible to attain a rotor in which the peaks of the counter-electromotive voltage that may be generated on the stator coil are reduced while increasing the torque of the rotating electrical machine. This structure can reduce the harmonic components of the plurality of target orders to be superposed on the fundamental component of the counter-electromotive voltage generated on the stator coil. Thus, it is possible to attain a rotor in which the peaks of the counter-electromotive voltage that may be generated on the stator coil are reduced effectively.

Further features and advantages of the rotor and the method for designing the rotor will become more apparent from the following description of an embodiment with reference to the drawings.

### BRIEF DESCRIPTION OF THE DRAWINGS

FIG. 1 is a sectional view orthogonal to an axial direction of a rotating electrical machine according to an embodiment.

FIG. 2 is an enlarged view of a part of FIG. 1.

FIG. 3 is an enlarged view of a part of FIG. 2.

FIG. 4 is a diagram illustrating changes in a salient pole difference and a salient pole ratio relative to a first angle.

FIG. 5 is a diagram illustrating a change in a fundamental component of a flux linkage relative to a second angle.

FIG. 6 is a diagram illustrating a change in an 11th order component of the flux linkage relative to the second angle.

FIG. 7 is a diagram illustrating a change in a 13th order component of the flux linkage relative to the second angle.

FIG. 8 is a diagram illustrating a change in a counter-electromotive voltage relative to a rotor position.

### DETAILED DESCRIPTION OF EMBODIMENTS

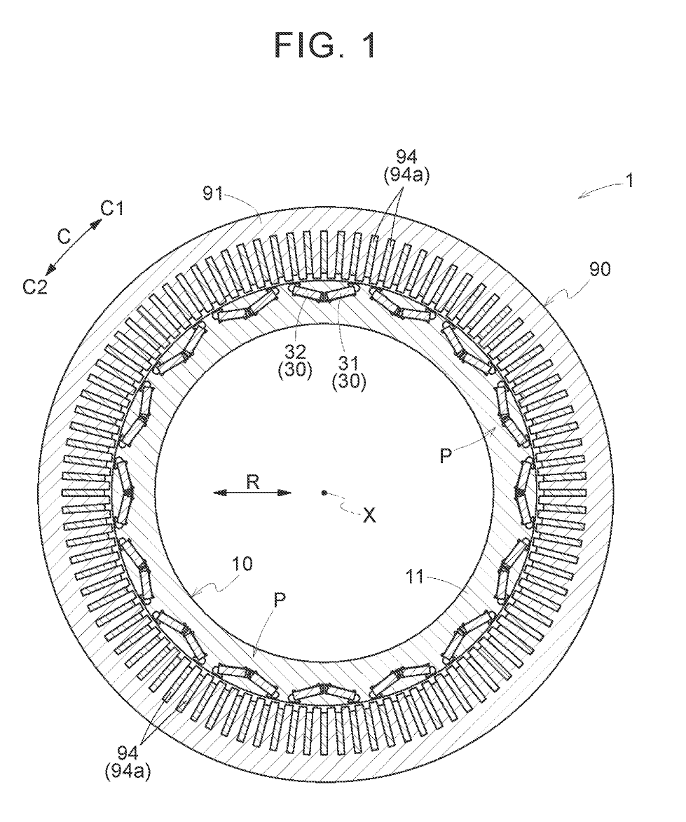

An embodiment of a rotor and a method for designing the rotor is described with reference to the drawings. In the following description, an “axial direction”, a “radial direction R”, and a “circumferential direction C” are defined with respect to a rotation axis X of a rotor core 11 (see FIG. 1). The rotation axis X is an imaginary axis, and the rotor core 11 rotates about the rotation axis X. One side in the circumferential direction C is defined as a “first circumferential side C1”, and the other side in the circumferential direction C (side opposite to the first circumferential side C1) is defined as a “second circumferential side C2”. Terms related to dimensions, arrangement directions, arrangement positions, and the like are herein used as concepts that encompass a condition with a difference caused by a deviation (deviation that is permissible in manufacturing).

As illustrated in FIG. 1, a rotor 10 is a rotor for an inner rotor type rotating electrical machine 1.

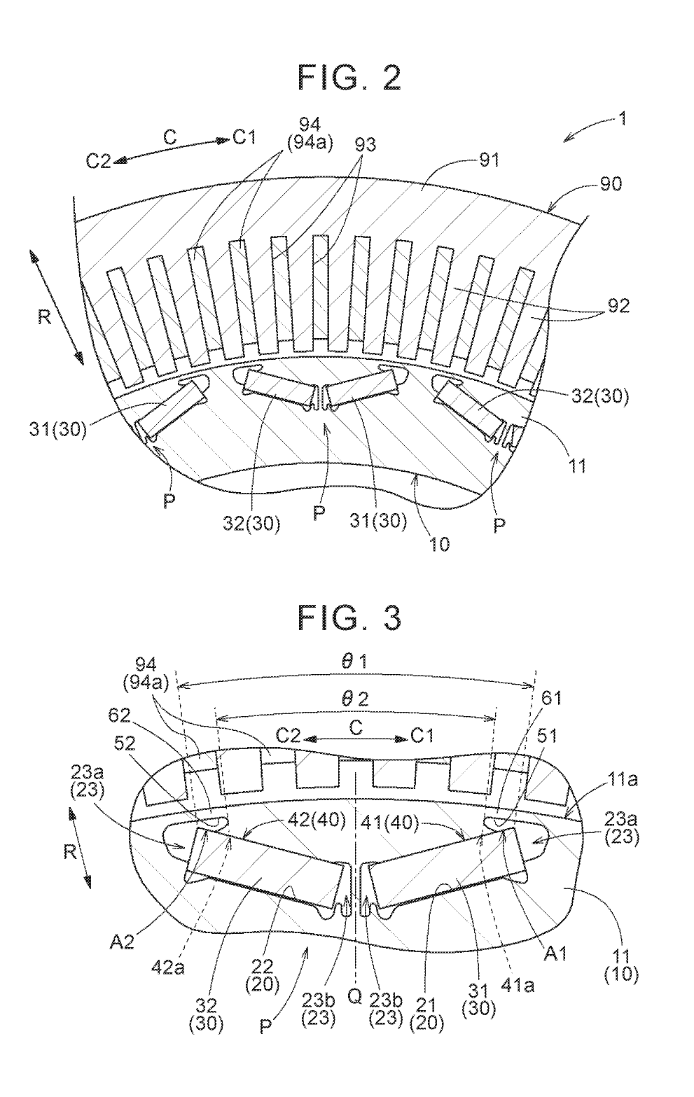

That is, the rotor 10 is arranged on an inner side in the radial direction R with respect to a stator 90 while being rotatable relative to the stator 90. The rotating electrical machine 1 is a revolving field type rotating electrical machine, and coils 94 (see FIG. 2) are would around a stator core 91 that is a core of the stator 90. In this embodiment, the rotating electrical machine 1 is a rotating electrical machine to be driven by three-phase alternating currents, and the coils 94 include three-phase coils that are a U-phase coil, a V-phase coil, and a W-phase coil. The rotor 10 rotates as a field system by a magnetic field generated from the stator 90. The “rotating electrical machine” is herein used as a concept that encompasses any of a motor (electric motor), a generator (power generator), and a motor/generator that functions as both the motor and the generator as necessary.

As illustrated in FIG. 2, a plurality of slots 93 extending in the axial direction and in the radial direction R are arranged in the stator core 91 while being distributed in the circumferential direction C. Each slot 93 has openings on both sides in the axial direction and on the inner side in the radial direction R. In this embodiment, each slot 93 is formed so that the width in the circumferential direction C is uniform along the radial direction R. The plurality of slots 93 are arranged at regular intervals along the circumferential direction C. In this embodiment, U-phase slots 93, V-phase slots 93, and W-phase slots 93 are arranged so as to appear repetitively along the circumferential direction C. In this example, the number of slots for each pole and each phase is “2”, and the slots 93 for each phase are arranged in the stator core 91 so that every two slots 93 appear repetitively along the circumferential direction C. The number of magnetic poles for each phase is “16” (the number of magnetic pole pairs is “8”), and a total of 96 (=2×16×3) slots 93 are arranged in the stator core 91. That is, in this example, as illustrated in FIG. 2, six slots 93 correspond to one magnetic pole P, and 12 slots 93 correspond to one magnetic pole pair. That is, in this embodiment, the number of slots M for one magnetic pole is “6”. A slot insertion portion 94a of the coil 94 is inserted into each slot 93. Thus, the coil 94 of the stator 90 is arranged so as to thee an outer peripheral surface 11a of the rotor core 11.

As illustrated in FIG. 1 and FIG. 2, the rotor 10 includes the rotor core 11 and permanent magnets 30 embedded in the rotor core 11. That is, the rotor 10 is a rotor to be used for a rotating electrical machine having an embedded magnet structure (in this embodiment, a synchronous electric motor). In the rotor core 11, magnet insertion holes 20 (see FIG. 3) in which the permanent magnets 30 are inserted are provided as many as the permanent magnets 30. The magnet insertion hole 20 is formed in the rotor core 11 so as to extend in the axial direction. In this embodiment, the magnet insertion hole 20 is formed so as to extend in parallel to the axial direction. The sectional shape of the magnet insertion hole 20 that is orthogonal to the axial direction is uniform along the axial direction. In this embodiment, the magnet insertion hole 20 is formed so as to pass through the rotor core 11 in the axial direction. The axial length of the permanent magnet 30 is a length based on the axial length of the magnet insertion hole 20. In this embodiment, the axial length of the permanent magnet 30 is equal to the axial length of the magnet insertion hole 20. For example, the rotor core 11 is formed by stacking a plurality of annular sheet-shaped magnetic sheets (for example, electromagnetic steel sheets) in the axial direction, or is formed by including, as a main component, a green compact obtained through pressure molding of magnetic powder that is powder of a magnetic material.

As illustrated in FIG. 1, the rotor core 11 is formed into a cylindrical shape coaxial with the rotation axis X. The outer peripheral surface 11a of the rotor core 11 (see FIG. 3) is formed into a cylindrical surface shape coaxial with the rotation axis X. In the rotor core 11, a plurality of magnetic poles P formed by the permanent magnets 30 and extending in the axial direction L are formed while being distributed in the circumferential direction C. Two magnetic poles P adjacent to each other in the circumferential direction C have opposite polarities. In this embodiment, 16 magnetic poles P are formed at regular intervals along the circumferential direction C. As illustrated in FIG. 2, each magnetic pole P is formed by a pair of permanent magnets 30 arranged side by side in the circumferential direction C. Of the pair of permanent magnets 30 that form one magnetic pole P, the permanent magnet 30 arranged on the first circumferential side C1 is defined as a first permanent magnet 31, and the permanent magnet 30 arranged on the second circumferential side C2 is defined as a second permanent magnet 32. The magnet insertion hole 20 in which the first permanent magnet 31 is inserted is defined as a first magnet insertion hole 21, and the magnet insertion hole 20 in which the second permanent magnet 32 is inserted is defined as a second magnet insertion hole 22 (see FIG. 3). That is, the first permanent magnet 31 is inserted into the first magnet insertion hole 21 formed in the rotor core 11 so as to extend in the axial direction, and the second permanent magnet 32 is inserted into the second magnet insertion hole 22 formed in the rotor core 11 so as to extend in the axial direction.

As illustrated in FIG. 3, the first permanent magnet 31 and the second permanent magnet 32 that structure one magnetic pole P are arranged plane-symmetrically across a reference plane Q. Along with this arrangement, the first magnet insertion hole 21 and the second magnet insertion hole 22 in which the pair of permanent magnets 30 that structure one magnetic pole P are inserted are formed into shapes that are plane-symmetrical across the reference plane Q. That is, the sectional shape of the first magnet insertion hole 21 that is orthogonal to the axial direction and the sectional shape of the second magnet insertion hole 22 that is orthogonal to the axial direction are shapes that are symmetrical across an axis of symmetry that is defined by a straight line along the reference plane Q. The reference plane Q is a plane passing through the rotation axis X (see FIG. 1) and extending in the radial direction R at a center between the pair of permanent magnets 30 that form one magnetic pole P. In other words, the reference plane Q is a plane passing through the rotation axis X and extending in the radial direction R at a central portion of the magnetic pole P in the circumferential direction C. The pair of permanent magnets 30 that structure one magnetic pole P are arranged so that magnetic pole surfaces 40 having the same polarity (N pole or S pole) are oriented toward an outer side in the radial direction R. The magnetic pole surface 40 is an outer surface orthogonal to a magnetizing direction (polarizing direction), and is a surface where a magnetic flux of the permanent magnet 30 flows in and out.

As illustrated in FIG. 3, a first magnetic pole surface 41 that is the magnetic pole surface 40 of the first permanent magnet 31 that is oriented toward the outer side in the radial direction R is arranged so that a portion of the first magnetic pole surface 41 that is closer to the first circumferential side C1 is located further outward in the radial direction R. A second magnetic pole surface 42 that is the magnetic pole surface 40 of the second permanent magnet 32 that is oriented toward the outer side in the radial direction R is arranged so that a portion of the second magnetic pole surface 42 that is closer to the second circumferential side C2 is located further outward in the radial direction R. In this embodiment, as illustrated in FIG. 3, the pair of permanent magnets 30 that structure one magnetic pole P are arranged in a V-shape so that the distance between the pair of permanent magnets 30 increases toward the outer side in the radial direction R in a cross section orthogonal to the axial direction. In this embodiment, the sectional shape of each permanent magnet 30 that is orthogonal to the axial direction is a rectangular shape, and the magnetizing direction is parallel to the short side of the rectangle. Thus, a surface that forms the long side of the rectangle in the outer peripheral surface of the permanent magnet 30 (surface that forms the outer edge of the cross section orthogonal to the axial direction) structures the magnetic pole surface 40. That is, in this embodiment, each of the first magnetic pole surface 41 and the second magnetic pole surface 42 is formed into a planar shape.

As illustrated in FIG. 3, in this embodiment, the magnet insertion hole 20 has magnetic resistance portions 23 that function as a magnetic resistance (flux barrier) to the magnetic flux flowing through the rotor core 11. The magnetic resistance portion 23 reduces a leakage flux of the permanent magnet 30. In this embodiment, assuming that a direction orthogonal to both the axial direction and the magnetizing direction (direction along the magnetic pole surface 40 in the cross section orthogonal to the axial direction) is a target direction, the magnetic resistance portions 23 are formed both at a part of the magnet insertion hole 20 on an outer side in the target direction and at a part of the magnet insertion hole 20 on an inner side in the target direction. The outer side in the target direction is a side in the target direction that is located away from the central portion of the magnetic pole P in the circumferential direction C. The inner side in the target direction is a side in the target direction that is located closer to the central portion of the magnetic pole P in the circumferential direction C. The magnetic resistance portion 23 formed at the part of the magnet insertion hole 20 on the outer side in the target direction is hereinafter referred to as an outer magnetic resistance portion 23a. The magnetic resistance portion 23 formed at the part of the magnet insertion hole 20 on the inner side in the target direction is hereinafter referred to as an inner magnetic resistance portion 23b. That is, in this embodiment, the outer magnetic resistance portion 23a is formed at a part of the first magnet insertion hole 21 on the first circumferential side C1 with respect to a region where the first permanent magnet 31 is arranged, and the inner magnetic resistance portion 23b is formed at a part of the first magnet insertion hole 21 on the second circumferential side C2 with respect to the region where the first permanent magnet 31 is arranged. Further, the outer magnetic resistance portion 23a is formed at a part of the second magnet insertion hole 22 on the second circumferential side C2 with respect to a region where the second permanent magnet 32 is arranged, and the inner magnetic resistance portion 23b is formed at a part of the second magnet insertion hole 22 on the first circumferential side C1 with respect to the region where the second permanent magnet 32 is arranged.

As illustrated in FIG. 3, the rotor core 11 includes a first hole portion 51 (first hole) and a second hole portion 52 (second hole). Each of the first hole portion 51 and the second hole portion 52 also functions as a magnetic resistance. Each of the first hole portion 51 and the second hole portion 52 is formed so as to extend in the axial direction. In this embodiment, each of the first hole portion 51 and the second hole portion 52 is formed so as to extend in parallel to the axial direction. The sectional shape of the first hole portion 51 that is orthogonal to the axial direction is uniform along the axial direction. The sectional shape of the second hole portion 52 that is orthogonal to the axial direction is uniform along the axial direction. In this embodiment, the first hole portion 51 and the second hole portion 52 are formed into shapes that are plane-symmetrical across the reference plane Q. That is, the sectional shape of the first hole portion 51 that is orthogonal to the axial direction and the sectional shape of the second hole portion 52 that is orthogonal to the axial direction are shapes that are symmetrical across the axis of symmetry that is defined by the straight line along the reference plane Q. In this embodiment, each of the first hole portion 51 and the second hole portion 52 is formed so as to pass through the rotor core 11 in the axial direction.

The first hole portion 51 is formed on the outer side in the radial direction R with respect to the first magnetic pole surface 41 at a position where the first hole portion 51 overlaps, as viewed in the radial direction R, a first end region A1 including the end of the first magnetic pole surface 41 on the first circumferential side C1. As illustrated in FIG. 3, assuming that a position where the first magnetic pole surface 41 overlaps the end of the first hole portion 51 on the second circumferential side C2 as viewed in the radial direction R is a first boundary portion 41a, the first end region A1 is a part of the first magnetic pole surface 41 on the first circumferential side C1 with respect to the first boundary portion 41a. The second hole portion 52 is formed on the outer side in the radial direction R with respect to the second magnetic pole surface 42 at a position where the second hole portion 52 overlaps, as viewed in the radial direction R, a second end region A2 including the end of the second magnetic pole surface 42 on the second circumferential side C2. As illustrated in FIG. 3, assuming that a position where the second magnetic pole surface 42 overlaps the end of the second hole portion 52 on the first circumferential side C1 as viewed in the radial direction R is a second boundary portion 42a, the second end region A2 is a part of the second magnetic pole surface 42 on the second circumferential side C2 with respect to the second boundary portion 42a. By providing the first hole portion 51 and the second hole portion 52 described above, the first hole portion 51 and the second hole portion 52 limit ranges in which coil flux linkage occurs on the first magnetic pole surface 41 and the second magnetic pole surface 42 while improving a reluctance torque (improving the usage of the reluctance torque) by appropriately setting ranges in the circumferential direction C in which the first magnetic pole surface 41 and the second magnetic pole surface 42 are arranged. Therefore, a harmonic component of a counter-electromotive voltage generated on the coil 94 can be reduced by adjusting a harmonic component of the coil flux linkage due to rotation of the rotor 10. Thus, the peaks of the counter-electromotive voltage that may be generated on the coil 94 can be reduced while increasing the torque of the rotating electrical machine 1.

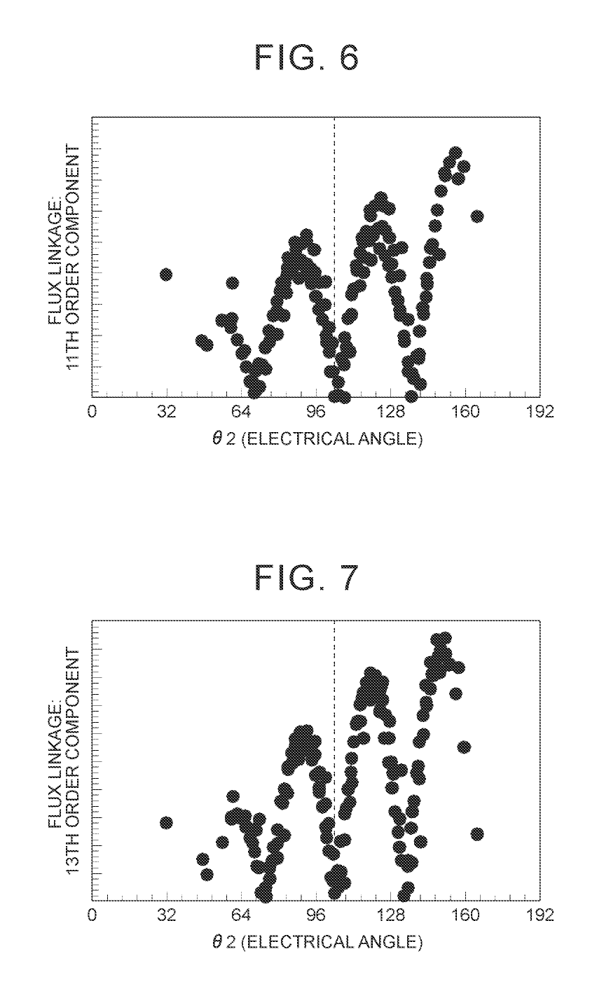

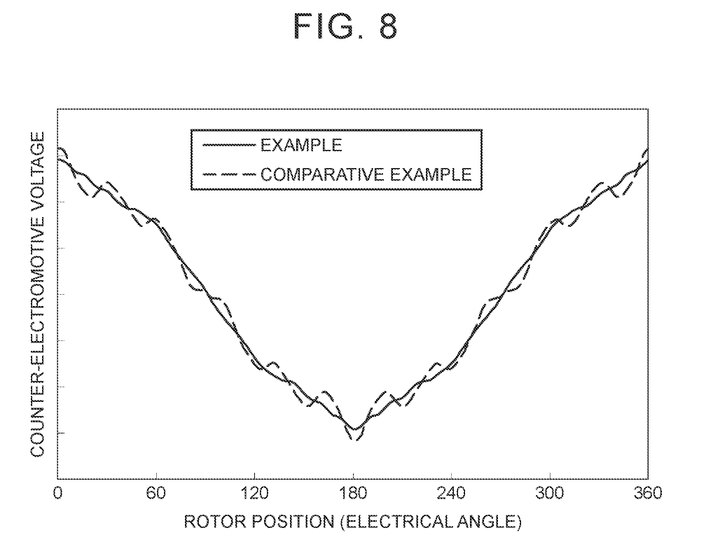

The first hole portion 51 and the second hole portion 52 are formed so that harmonic components of the plurality of target orders on a fundamental component of the counter-electromotive voltage generated by the rotation of the rotor 10 are reduced as compared to a case where the first hole portion 51 and the second hole portion 52 are not provided. That is, the shapes of the first hole portion 51 and the second hole portion 52 are designed for that purpose. Focusing on, for example, harmonic components of specific orders in the coil flux linkage that is linked to the coil 94 as illustrated in FIG. 6 and FIG. 7, the magnetic flux amount of the harmonic component of each order periodically increases and decreases in accordance with a second angle θ2 that is an angle in the circumferential direction C in a region of a combination of a part of the first magnetic pole surface 41 that does not overlap the first hole portion 51 and a part of the second magnetic pole surface 42 that does not overlap the second hole portion 52. Therefore, in this embodiment, the first hole portion 51 and the second hole portion 52 are formed so as to deviate from the peaks of the periodic increase and decrease in accordance with the second angle θ2 in the harmonic components of the plurality of target orders among the harmonic components of the coil flux linkage. Thus, the harmonic components of the plurality of target orders are reduced as compared to the case where the first hole portion 51 and the second hole portion 52 are not provided. This structure also reduces harmonic components to be superposed on the fundamental component of the counter-electromotive voltage generated on the coil 94. Thus, for example, the peaks of the counter-electromotive voltage generated on the coil 94 can be reduced as indicated by a continuous line (example) in FIG. 8 as compared to a case where a large amount of the harmonic component is superposed as indicated by a dashed line (comparative example) in FIG. 8.

In this embodiment, when M represents the number of slots for one magnetic pole in the stator 90, the plurality of target orders that are reduction targets include at least a (2M−1)th order and a (2M+1)th order. This structure can reduce harmonic components of orders that particularly have significant influence among the harmonic components to be superposed on the fundamental component of the counter-electromotive voltage. That is, firstly, the change in the flux linkage (magnetic flux waveform) can approximate a rectangular wave, and therefore components of even number orders do not basically exist in the flux linkage. When the rotating electrical machine 1 is driven by three-phase alternating currents and when the phase coils of the respective phases are connected by Y-connection (star connection), 3n-th order (n is a natural number) components do not appear in a line-to-line voltage while being canceled. Further, higher-order harmonic components of a (2M+3)th order and higher do not significantly influence the counter-electromotive voltage. The magnetic resistance is higher at the openings of the slots 93 than teeth 92. Therefore, when M represents the number of slots for each magnetic pole P, the magnetic resistance increases at 2M points in one period of an electrical angle. Based on the facts described above, the harmonic components of the (2M−1)th order and the (2M+1)th order particularly have significant influence among the harmonic components of the flux linkage on the coil 94 and furthermore the harmonic components to be superposed on the fundamental component of the counter-electromotive voltage. By setting the plurality of target orders that are reduction targets as described above, it is possible to effectively reduce the peaks of the counter-electromotive voltage that may be generated on the coil 94.

In this embodiment, the first hole portion 51 is formed integrally with the first magnet insertion hole 21 so as to communicate with the first magnet insertion hole 21. Further, the second hole portion 52 is formed integrally with the second magnet insertion hole 22 so as to communicate with the second magnet insertion hole 22. Specifically, a part of the first hole portion 51 on the first circumferential side C1 communicates with a part of the outer magnetic resistance portion 23a of the first magnet insertion hole 21 on the outer side in the radial direction R, and a part of the first hole portion 51 on the inner side in the radial direction R communicates with a part of the first magnet insertion hole 21 on the first circumferential side C1 in the region where the first permanent magnet 31 is arranged. Further, a part of the second hole portion 52 on the second circumferential side C2 communicates with a part of the outer magnetic resistance portion 23a of the second magnet insertion hole 22 on the outer side in the radial direction R, and a part of the second hole portion 52 on the inner side in the radial direction R communicates with a part of the second magnet insertion hole 22 on the second circumferential side C2 in the region where the second permanent magnet 32 is arranged. In this embodiment, the end of the first hole portion 51 on the second circumferential side C2 does not communicate with the first magnet insertion hole 21 in the radial direction R, and is formed away from the first magnet insertion hole 21 toward the outer side in the radial direction R. In this embodiment, the end of the second hole portion 52 on the first circumferential side C1 does not communicate with the second magnet insertion hole 22 in the radial direction R, and is formed away from the second magnet insertion hole 22 toward the outer side in the radial direction R. In this embodiment, each of the first hole portion 51 and the second hole portion 52 is a hollow, but may have a structure filled with a non-magnetic substance.

As illustrated in FIG. 3, in this embodiment, each of the inner surface of the first hole portion 51 on the outer side in the radial direction R and the inner surface of the second hole portion 52 on the outer side in the radial direction R has a part parallel to the outer peripheral surface 11a of the rotor core 11. Specifically, a part other than the end on the second circumferential side C2 in the inner surface of the first hole portion 51 On the outer side in the radial direction R is formed in parallel to the outer peripheral surface 11a of the rotor core 11, and a part other than the end on the first circumferential side C 1 in the inner surface of the second hole portion 52 on the outer side in the radial direction R is formed in parallel to the outer peripheral surface 11a of the rotor core 11. Thus, the shape of a bridge portion (first bridge portion 61) formed between the first hole portion 51 and the outer peripheral surface 11a of the rotor core 11 in the radial direction R and the shape of a bridge portion (second bridge portion 62) formed between the second hole portion 52 and the outer peripheral surface 11a of the rotor core 11 in the radial direction R can be set to a shape that is narrow in the radial direction R and is long in the circumferential direction C (elongated shape extending in the circumferential direction C as viewed in the axial direction), thereby facilitating the occurrence of magnetic saturation in those bridge portions. As a result, the leakage flux of the permanent magnet 30 can further be reduced.

In this embodiment, the inner surface of the outer magnetic resistance portion 23a on the outer side in the radial direction R also has a part parallel to the outer peripheral surface 11a of the rotor core 11. Specifically, in the first magnet insertion hole 21, a part other than the end on the first circumferential side C1 in the inner surface of the outer magnetic resistance portion 23a on the outer side in the radial direction t is formed in parallel to the outer peripheral surface 11a of the rotor core 11. In the second magnet insertion hole 22, a part other than the end on the second circumferential side C2 in the inner surface of the outer magnetic resistance portion 23a on the outer side in the radial direction R is formed in parallel to the outer peripheral surface 11a of the rotor core 11.

As illustrated in FIG. 3, an angle formed in the circumferential direction C about the rotation axis X (see FIG. 1) between the end of the first magnetic pole surface 41 on the first circumferential side C1 and the end of the second magnetic pole surface 42 on the second circumferential side C2 is defined as a first angle 91. Further, an angle formed in the circumferential direction C about the rotation axis X between the end of the first magnetic pole surface 41 on the first circumferential side C1 at the part that does not overlap the first hole portion 51 as viewed in the radial direction R (first boundary portion 41a) and the end of the second magnetic pole surface 42 on the second circumferential side C2 at the part that does not overlap the second hole portion 52 as viewed in the radial direction R (second boundary portion 42a) is defined as the second angle 82. Designing is performed for the formation of the first hole portion 51 and the second hole portion 52 so that the second angle θ2 corresponds to an electrical angle at which the harmonic components of the plurality of target orders on the fundamental component of the counter-electromotive voltage generated by the rotation of the rotor 10 are reduced together. Regarding the structure according to this embodiment, the inventors have found that the peaks of the counter-electromotive voltage that may be generated on the coil 94 can be reduced while increasing the torque of the rotating electrical machine 1 by setting the first angle θ1 to an angle within a range of 128°±10° in terms of the electrical angle and setting the second angle θ2 to an angle within a range of 104°±10° in terms of the electrical angle.

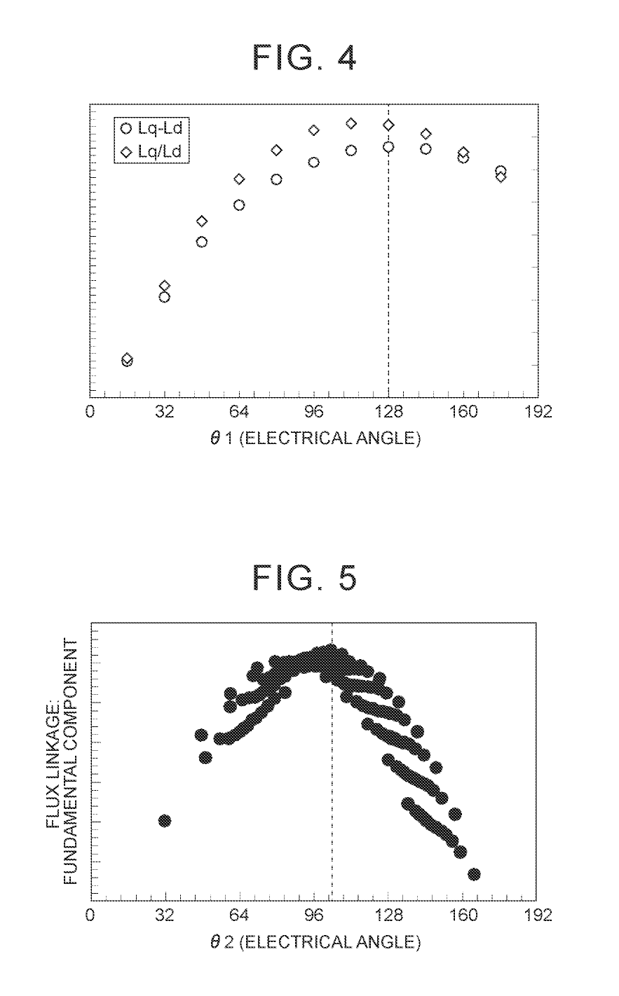

Specifically, by setting the first angle θ1 to the angle within the range of 128°±10° in terms of the electrical angle, a large difference is secured between a q-axis inductance and a d-axis inductance. Thus, the reluctance torque can be improved (the usage of the reluctance torque can be improved). FIG. 4 illustrates results of simulation of changes in a salient pole difference and a salient pole ratio relative to the first angle θ1 for the rotor 10 according to this embodiment described with reference to FIG. 1 to FIG. 3. The salient pole difference is the difference (Lq−Ld) between the q-axis inductance (Lq) and the d-axis inductance (Ld). The salient pole ratio is the ratio (Lq/Ld) between the q-axis inductance (Lq) and the d-axis inductance (Ld). FIG. 4 demonstrates that the salient pole difference is maximum when the first angle θ1 is 128° in terms of the electrical angle. The reluctance torque is proportional to the salient pole difference. Thus, the reluctance torque is maximum when the first angle θ1 is 128° in terms of the electrical angle. Accordingly, the first angle θ1 is set with respect to the angle at which the salient pole difference is maximum. It is further appropriate that the first angle θ1 be set to an angle within a range of 128°±5° in terms of the electrical angle.

By setting the second angle θ2 to the angle within the range of 104°±10° in terms of the electrical angle, an 11th order component and a 13th order component of the flux linkage (coil flux linkage) are both reduced, and therefore the peaks of the counter-electromotive voltage can be reduced. Further, the leakage fluxes of the first permanent magnet 31 and the second permanent magnet 32 are reduced by the first hole portion 51 and the second hole portion 52, respectively, and therefore a magnet torque can be improved (the usage of the magnet torque can be improved). FIG. 5 to FIG. 7 illustrate results of simulation for the rotor 10 according to this embodiment described with reference to FIG. 1 to FIG. 3. FIG. 5 illustrates a change in a fundamental component of the flux linkage relative to the second angle θ2. FIG. 6 illustrates a change in the 11th order component of the flux linkage relative to the second angle θ2. FIG. 7 illustrates a change in the 13th order component of the flux linkage relative to the second angle θ2. The first angle θ1 is set to 128° in terms of the electrical angle. FIG. 5 to FIG. 7 demonstrate that the amplitude of the fundamental component of the flux linkage is maximum or close to the maximum and the amplitudes of both the 11th order component and the 13th order component of the flux linkage are minimum or close to the minimum when the second angle θ2 is 104° in terms of the electrical angle (angle indicated by dashed lines in the figures). That is, when the second angle θ2 is 104° in terms of the electrical angle, the amplitude of the fundamental component of the flux linkage that contributes to the magnet torque is increased and the amplitudes of the 11th order component and the 13th order component of the flux linkage that cause an increase in the peaks of the counter-electromotive voltage are reduced to lower levels. Accordingly, the second angle θ2 is set with respect to the angle at which the amplitudes of the 11th order component and the 13th order component of the flux linkage are minimum. The range of the second angle θ2 from 94° to 114° in terms of the electrical angle is a range that does not include an angle at which the amplitude of the 11th order component of the flux linkage is maximum and an angle at which the amplitude of the 13th order component of the flux linkage is maximum. From the viewpoint of reducing the peaks of the counter-electromotive voltage, it is further appropriate that the second angle θ2 be set to an angle within a range of 104°±5° in terms of the electrical angle.

FIG. 8 illustrates results of simulation of a change in the counter-electromotive voltage relative to a rotor position in the case where the first angle θ1 is set to 128° in terms of the electrical angle and the second angle θ2 is set to 104° in terms of the electrical angle. The counter-electromotive voltage indicated by the dashed line as the comparative example is a result of simulation in the case where the first hole portion 51 and the second hole portion 52 are not provided. The counter-electromotive voltage corresponds to a time derivative of the flux linkage, and therefore the harmonic component of the flux linkage is included in the counter-electromotive voltage as a harmonic component of the same order. FIG. 8 demonstrates that the harmonic components to be superposed on the fundamental component of the counter-electromotive voltage are reduced and the waveform of the counter-electromotive voltage approximates a sinusoidal wave when the first hole portion 51 and the second hole portion 52 are provided and when the first angle θ1 is set to 128° in terms of the electrical angle and the second angle θ2 is set to 104° in terms of the electrical angle.

The reason why the peaks of the counter-electromotive voltage are reduced by reducing the 11th order component and the 13th order component of the flux linkage is as follows. Firstly the change in the flux linkage (magnetic flux waveform) can approximate a rectangular wave, and therefore components of even number orders do not basically exist in the flux linkage. Further, the rotating electrical machine 1 according to this embodiment is a rotating electrical machine to be driven by three-phase alternating currents. Therefore, when the phase coils of the respective phases are connected by Y-connection (star connection), 3n-th order (n is a natural number) components do not appear in a line-to-line voltage while being canceled. Further, higher-order components of a 17th order and higher are generated, but do not significantly influence the counter-electromotive voltage. Therefore, 5th, 7th, 11th, and 13th order components may be included in the flux linkage as major components. As described above, in this embodiment, the number of slots M for one magnetic pole is “6”, and 12 slots 93 correspond to one magnetic pole pair. The magnetic resistance is higher at the openings of the slots 93 than the teeth 92. Therefore, the magnetic resistance increases at 12 points in one period of the electrical angle. As a result, the components of the 11th and 13th orders that are (12±1)th orders prevail in the rotor 10 according to this embodiment.

### Other Embodiments

Other embodiments of the rotor are described. The structures disclosed in the following embodiments are also applicable in combination with the structures disclosed in the other embodiments without causing any contradiction.

(1) In the embodiment described above, description is given of the exemplary structure in which the first hole portion 51 and the second hole portion 52 are formed so that the harmonic components of the plurality of target orders in the counter-electromotive voltage are reduced. However, the present disclosure is not limited to this structure. It is also appropriate to employ a structure in which the first hole portion 51 and the second hole portion 52 are formed so that a harmonic component of one target order is reduced. This structure can also reduce the peaks of the counter-electromotive voltage that may be generated on the coil 94.

(2) in the embodiment described above, description is given of the exemplary structure in which the plurality of target orders include at least the (2M−1)th order and the (2M+1)th order. However, the present disclosure is not limited to this structure. It is also appropriate that harmonic components of orders other than the (2M−1)th order and the (2M+1)th order be set as target orders and the first hole portion 51 and the second hole portion 52 be formed so that the harmonic components of the target orders are reduced. This structure can also reduce the peaks of the counter-electromotive voltage that may be generated on the coil 94.

(3) in the embodiment described above, description is given of the exemplary structure in which the first hole portion 51 is formed integrally with the first magnet insertion hole 21 so as to communicate with the first magnet insertion hole 21 and the second hole portion 52 is formed integrally with the second magnet insertion hole 22 so as to communicate with the second magnet insertion hole 22. However, the present disclosure is not limited to this structure. There may be employed a structure in which one or both of the first hole portion 51 and the second hole portion 52 are formed as holes independent of the magnet insertion holes 20 (the first magnet insertion hole 21 for the first hole portion 51 and the second magnet insertion hole 22 for the second hole portion 52).

(4) In the embodiment described above, description is given of the exemplary structure in which each of the inner surface of the first hole portion 51 on the outer side in the radial direction R and the inner surface of the second hole portion 52 on the outer side in the radial direction R has the part parallel to the outer peripheral surface 11a of the rotor core 11 However, the present disclosure is not limited to this structure. There may be employed a structure in which one or both of the inner surface of the first hole portion 51 on the outer side in the radial direction R and the inner surface of the second hole portion 52 on the outer side in the radial direction R do not have the part parallel to the outer peripheral surface 11a of the rotor core 11.

(5) In the embodiment described above, description is given of the exemplary structure in which the number of slots for each pole and each phase is “2” and the number of slots for one magnetic pole is “6”. However, the present disclosure is not limited to this structure. The number of slots for each pole and each phase may be “1” or an integer equal to or larger than “3”, and accordingly the number of slots M for one magnetic pole may be any number that is an integral multiple of the number of phases of alternating currents.

(6) In the embodiment described above, description is given of the exemplary structure in which the number of magnetic poles for each phase is “16”. However, the present disclosure is not limited to this structure. There may be employed a structure in which the number of magnetic poles for each phase is a number other than “16”. For example, there may be employed a structure in which the number of magnetic poles for each phase is “8” or “12”.

(7) Regarding other structures as well, it should be understood that the embodiment disclosed herein is only illustrative in all respects. Thus, various modifications may be made as appropriate by persons having ordinary skill in the art without departing from the spirit of the disclosure.

### Summary of Embodiment

A summary of the rotor described above is described below.

The rotor (10) is the rotor (10) for the inner rotor type rotating electrical machine (1), including the rotor core (11) and the permanent magnets (30) embedded in the rotor core (11). The magnetic poles (P) are each formed by a pair of the permanent magnets (30) arranged side by side in the circumferential direction (C). Of the pair of the permanent magnets (30) that form one of the magnetic poles (P), the permanent magnet (30) arranged on the first circumferential side (C1) that is one side in the circumferential direction (C) is defined as the first permanent magnet (31), and the permanent magnet (30) arranged on the second circumferential side (C2) that is the other side in the circumferential direction (C) is defined as the second permanent magnet (32). The first magnetic pole surface (41) that is the magnetic pole surface (40) of the first permanent magnet (31) that is oriented toward the outer side in the radial direction (R) is arranged so that the portion of the first magnetic pole surface (41) that is closer to the first circumferential side (C1) is located further outward in the radial direction (R). The second magnetic pole surface (42) that is the magnetic pole surface (40) of the second permanent magnet (32) that is oriented toward the outer side in the radial direction (R) is arranged so that the portion of the second magnetic pole surface (42) that is closer to the second circumferential side (C2) is located further outward in the radial direction (R). The rotor core (11) includes the first hole portion (51) formed on the outer side in the radial direction (R) with respect to the first magnetic pole surface (41) at the position where the first hole portion (51) overlaps, as viewed in the radial direction (R), the first end region (A1) including the end of the first magnetic pole surface (41) on the first circumferential side (C1), and the second hole portion (52) formed on the outer side in the radial direction (R) with respect to the second magnetic pole surface (42) at the position where the second hole portion (52) overlaps, as viewed in the radial direction (R), the second end region (A2) including the end of the second magnetic pole surface (42) on the second circumferential side (C2).

According to the structure described above, the first hole portion (51) and the second hole portion (52) limit the ranges in which the coil flux linkage occurs on the first magnetic pole surface (41) and the second magnetic pole surface (42) while improving the reluctance torque (improving the usage of the reluctance torque) by appropriately setting the ranges in the circumferential direction (C) in which the first magnetic pole surface (41) and the second magnetic pole surface (42) are arranged. Therefore, the harmonic component of the counter-electromotive voltage generated on the stator coil (94) can be reduced by adjusting the harmonic component of the coil flux linkage due to the rotation of the rotor (10). Thus, the peaks of the counter-electromotive voltage that may be generated on the stator coil (94) can be reduced while increasing the torque of the rotating electrical machine (1),

It is appropriate that the first hole portion (51) and the second hole portion (52) be formed so that the harmonic components of the plurality of target orders on the fundamental component of the counter-electromotive voltage generated by the rotation of the rotor (10) on the coil (94) of the stator (90) arranged so as to face the outer peripheral surface (11a) of the rotor core (11) are reduced as compared to the case where the first hole portion (51) and the second hole portion (52) are not provided.

This structure can reduce the harmonic components of the plurality of target orders to be superposed on the fundamental component of the counter-electromotive voltage generated on the stator coil (94). Thus, it is possible to effectively reduce the peaks of the counter-electromotive voltage that may be generated on the stator coil (94).

It is appropriate that, when M represents the number of slots for one of the magnetic poles in the stator (90), the plurality of target orders include at least the (2M−1)th order and the (2M+1)th order.

This structure can reduce the harmonic components of the orders that particularly have significant influence among the harmonic components to be superposed on the fundamental component of the counter-electromotive voltage. Thus, it is possible to further effectively reduce the peaks of the counter-electromotive voltage that may be generated on the stator coil (94).

It is appropriate that the angle (θ1) formed in the circumferential direction (C) about the rotation axis (X) of the rotor core (11) between the end of the first magnetic pole surface (41) on the first circumferential side (C1) and the end of the second magnetic pole surface (42) on the second circumferential side (C2) be the angle within the range of 128°±10° in terms of the electrical angle, and the angle (θ2) formed in the circumferential direction (C) about the rotation axis (X) between the end of the first magnetic pole surface (41) on the first circumferential side (C1) at the part that does not overlap the first hole portion (51) as viewed in the radial direction (R) and the end of the second magnetic pole surface (42) on the second circumferential side (C2) at the part that does not overlap the second hole portion (52) as viewed in the radial direction (R) be the angle within the range of 104°±10° in terms of the electrical angle.

By providing the first hole portion (51) and the second hole portion (52) described above, magnetic characteristics of the rotor (10) can be designed not only by the angle (hereinafter referred to as “first angle”) formed in the circumferential direction (C) about the rotation axis (X) of the rotor core (11) between the end of the first magnetic pole surface (41) on the first circumferential side (C1) and the end of the second magnetic pole surface (42) on the second circumferential side (C2) but also by the angle (hereinafter referred to as “second angle”) formed in the circumferential direction (C) about the rotation axis (X) of the rotor core (11) between the end of the first magnetic pole surface (41) on the first circumferential side (C1) at the part that does not overlap the first hole portion (51) as viewed in the radial direction (R) and the end of the second magnetic pole surface (42) on the second circumferential side (C2) at the part that does not overlap the second hole portion (52) as viewed in the radial direction (R). As a result of extensive studies, the inventors have found that the peaks of the counter-electromotive voltage that may be generated on the coil (94) can be reduced while increasing the torque of the rotating electrical machine (1) by setting the first angle (θ1) to the angle within the range of 128°±10° in terms of the electrical angle and setting the second angle (θ2) to the angle within the range of 104°±10° in terms of the electrical angle as in the structure described above. That is, by setting the first angle (θ1) to the angle within the range of 128°±10° in tarns of the electrical angle, a large difference is secured between the q-axis inductance and the d-axis inductance. Thus, the reluctance torque can be improved (the usage of the reluctance torque can be improved). By setting the second angle (θ2) to the angle within the range of 104°±10° in terms of the electrical angle, the 11th order component and the 13th order component of the flux linkage are both reduced, and therefore the peaks of the counter-electromotive voltage can be reduced. Further, the leakage fluxes of the first permanent magnet (31) and the second permanent magnet (32) are reduced by the first hole portion (51) and the second hole portion (52), respectively, and therefore the magnet torque can be improved (the usage of the magnet torque can be improved).

It is appropriate that the first permanent magnet (31) be inserted into the first magnet insertion hole (21) formed in the rotor core (11) so as to extend in the axial direction, the second permanent magnet (32) be inserted into the second magnet insertion hole (22) formed in the rotor core (11) so as to extend in the axial direction, the first hole portion (51) be formed integrally with the first magnet insertion hole (21) so as to communicate with the first magnet insertion hole (21), and the second hole portion (52) be formed integrally with the second magnet insertion hole (22) so as to communicate with the second magnet insertion hole. (22).

This structure can further reduce the leakage flux of the first permanent magnet (31) by using the communicating part between the first hole portion (51) and the first magnet insertion hole (21), and can further reduce the leakage flux of the second permanent magnet (32) by using the communicating part between the second hole portion (52) and the second magnet insertion hole (22). The structure described above facilitates manufacturing of the rotor core (11) as compared to the case where the first hole portion (51) is formed as a hole independent of the first magnet insertion hole (21) and the case where the second hole portion (52) is formed as a hole independent of the second magnet insertion hole (22).

It is appropriate that each of the inner surface of the first hole portion (51) on the outer side in the radial direction (R) and the inner surface of the second hole portion (52) on the outer side in the radial direction (R) have the part parallel to the outer peripheral surface (11a) of the rotor core (11).

According to this structure, the shape of the bridge portion (61) formed between the first hole portion (51) and the outer peripheral surface (11a ) of the rotor core (11) in the radial direction (R) and the shape of the bridge portion (62) formed between the second hole portion (52) and the outer peripheral surface (11a) of the rotor core (11) in the radial direction (R) can be set to a shape that is narrow in the radial direction (R) and is long in the circumferential direction (C) (elongated shape extending in the circumferential direction (C) as viewed in the axial direction). Thus, the occurrence of magnetic saturation is facilitated in those bridge portions (61, 62). As a result, the leakage flux of the permanent magnet (30) can be reduced to a lower level,

The method for designing the rotor (10) is the method for designing the rotor (10) for the inner rotor type rotating electrical machine (1), including the rotor core (11) and the permanent magnets (30) embedded in the rotor core (11). The magnetic poles (P) are each formed by a pair of the permanent magnets (30) arranged side by side in the circumferential direction (C). Of the pair of the permanent magnets (30) that form one of the magnetic poles (P), the permanent magnet (30) arranged on the first circumferential side (C1) that is one side in the circumferential direction (C) is defined as the first permanent magnet (31), and the permanent magnet (30) arranged on the second circumferential side (C2) that is the other side in the circumferential direction (C) is defined as the second permanent magnet (32). The first magnetic pole surface (41) that is the magnetic pole surface (40) of the first permanent magnet (31) that is oriented toward the outer side in the radial direction (R) is arranged so that the portion of the first magnetic pole surface (41) that is closer to the first circumferential side (C1) is located further outward in the radial direction (R). The second magnetic pole surface (42) that is the magnetic pole surface (40) of the second permanent magnet (32) that is oriented toward the outer side in the radial direction (R) is arranged so that the portion of the second magnetic pole surface (42) that is closer to the second circumferential side (C2) is located further outward in the radial direction (R). The rotor core (11) includes the first hole portion (51) formed on the outer side in the radial direction (R) with respect to the first magnetic pole surface (41) at the position where the first hole portion (51) overlaps, as viewed in the radial direction (R), the first end region (A1) including the end of the first magnetic pole surface (41) on the first circumferential side (C1), and the second hole portion (52) formed on the outer side in the radial direction (R) with respect to the second magnetic pole surface (42) at the position where the second hole portion (52) overlaps, as viewed in the radial direction (R), the second end region (A2) including the end of the second magnetic pole surface (42) on the second circumferential side (C2). The first hole portion (51) and the second hole portion (52) are formed so that the harmonic components of the plurality of target orders on the fundamental component of the counter-electromotive voltage generated by the rotation of the rotor (10) on the coil (94) of the stator (90) arranged so as to face the outer peripheral surface (11a) of the rotor core (11) are reduced as compared to the case where the first hole portion (51) and the second hole portion (52) are not provided.

According to the structure described above, the first hole portion (51) and the second hole portion (52) limit the ranges in which the coil flux linkage occurs on the first magnetic pole surface (41) and the second magnetic pole surface (42) while improving the reluctance torque (improving the usage of the reluctance torque) by appropriately setting the ranges in the circumferential direction (C) in which the first magnetic pole surface (41) and the second magnetic pole surface (42) are arranged. Therefore, the harmonic component of the counter-electromotive voltage generated on the stator coil (94) can be reduced by adjusting the harmonic component of the coil flux linkage due to the rotation of the rotor (10). Thus, it is possible to attain a rotor in which the peaks of the counter-electromotive voltage that may be generated on the stator coil (94) are reduced while increasing the torque of the rotating electrical machine (1). This structure can reduce the harmonic components of the plurality of target orders to be superposed on the fundamental component of the counter-electromotive voltage generated on the stator coil (94). Thus, it is possible to attain a rotor in which the peaks of the counter-electromotive voltage that may be generated on the stator coil (94) are reduced effectively.

In the designing method, it is appropriate that the first hole portion and the second hole portion be formed so that the angle formed in the circumferential direction about the rotation axis between the end of the first magnetic pole surface on the first circumferential side at the part that does not overlap the first hole portion as viewed in the radial direction and the end of the second magnetic pole surface on the second circumferential side at the part that does not overlap the second hole portion as viewed in the radial direction corresponds to the electrical angle at which the harmonic components of the plurality of target orders on the fundamental component of the counter-electromotive voltage are reduced together.

This structure can reduce together the harmonic components of the plurality of target orders to be superposed on the fundamental component of the counter-electromotive voltage generated on the stator coil (94). Thus, it is possible to attain a rotor in which the peaks of the counter-electromotive voltage that may be generated on the stator coil (94) are reduced effectively.

In the designing method, it is appropriate that the angle (θ1) formed in the circumferential direction (C) about the rotation axis (X) of the rotor core (11) between the end of the first magnetic pole surface (41) on the first circumferential side (C1) and the end of the second magnetic pole surface (42) on the second circumferential side (C2) be set to the angle within the range of 128°±10° in terms of the electrical angle, and the angle (θ2) formed in the circumferential direction (C) about the rotation axis (X) between the end of the first magnetic pole surface (41) on the first circumferential side (C1) at the part that does not overlap the first hole portion (51) as viewed in the radial direction (R) and the end of the second magnetic pole surface (42) on the second circumferential side (C2) at the part that does not overlap the second hole portion (52) as viewed in the radial direction (R) be set to the angle within the range of 104°±10° in terms of the electrical angle.

Thus, the magnetic characteristics of the rotor (10) can be designed not only by the angle (hereinafter referred to as “first angle”) formed in the circumferential direction (C) about the rotation axis (X) of the rotor core (11) between the end of the first magnetic pole surface (41) on the first circumferential side (C1) and the end of the second magnetic pole surface (42) on the second circumferential side (C2) but also by the angle (hereinafter referred to as “second angle”) formed in the circumferential direction (C) about the rotation axis (X) of the rotor core (11) between the end of the first magnetic pole surface (41) on the first circumferential side (C1) at the part that does not overlap the first hole portion (51) as viewed in the radial direction (R) and the end of the second magnetic pole surface (42) on the second circumferential side (C2) at the part that does not overlap the second hole portion (52) as viewed in the radial direction (R). As a result of extensive studies, the inventors have found that the peaks of the counter-electromotive voltage that may be generated on the coil (94) can be reduced while increasing the torque of the rotating electrical machine (1) by setting the first angle (θ1) to the angle within the range of 128°±10° in terms of the electrical angle and setting the second angle (θ2) to the angle within the range of 104°±10° in terms of the electrical angle as in the structure described above. That is, by setting the first angle (θ1) to the angle within the range of 128°±10° in terms of the electrical angle, a large difference is secured between the q-axis inductance and the d-axis inductance. Thus, the reluctance torque can be improved (the usage of the reluctance torque can be improved). By setting the second angle (θ2) to the angle within the range of 104°±10° in terms of the electrical angle, the 11th order component and the 13th order component of the flux linkage are both reduced, and therefore the peaks of the counter-electromotive voltage can be reduced. Further, the leakage fluxes of the first permanent magnet (31) and the second permanent magnet (32) are reduced by the first hole portion (51) and the second hole portion (52), respectively, and therefore the magnet torque can be improved (the usage of the magnet torque can be improved).

1. A rotor for an inner rotor rotating electrical machine, the rotor comprising
a rotor core; and
permanent magnets embedded in the rotor core, wherein:
magnetic poles are each formed by a pair of the permanent magnets arranged side by side in a circumferential direction,
of the pair of the permanent magnets that form one of the magnetic poles, the permanent magnet arranged on a first circumferential side that is one side in the circumferential direction is defined as a first permanent magnet, and the permanent magnet arranged on a second circumferential side that is the other side in the circumferential direction is defined as a second permanent magnet,
a first magnetic pole surface that is a magnetic pole surface of the first permanent magnet that is oriented toward an outer side in a radial direction is arranged so that a portion of the first magnetic pole surface that is closer to the first circumferential side is located further outward in the radial direction,
a second magnetic pole surface that is a magnetic pole surface of the second permanent magnet that is oriented toward the outer side in the radial direction is arranged so that a portion of the second magnetic pole surface that is closer to the second circumferential side is located further outward in the radial direction, and
the rotor core includes a first hole formed on the outer side in the radial direction with respect to the first magnetic pole surface at a position where the first hole overlaps, as viewed in the radial direction, a first end region including an end of the first magnetic pole surface on the first circumferential side, and a second hole formed on the outer side in the radial direction with respect to the second magnetic pole surface at a position where the second hole overlaps, as viewed in the radial direction, a second end region including an end of the second magnetic pole surface on the second circumferential side.

2. The rotor according to claim 1, wherein the first hole and the second hole are formed so that harmonic components of a plurality of target orders on a fundamental component of a counter-electromotive voltage generated by rotation of the rotor on a coil of a stator arranged so as to face an outer peripheral surface of the rotor core are reduced as compared to a case where the first hole and the second hole are not provided.

3. The rotor according to claim 2, wherein, when M represents the number of slots for one of the magnetic poles in the stator, the plurality of target orders include at least a (2M−1)th order and a (2M+1)th order.

4. The rotor according to claim 1, wherein
an angle formed in the circumferential direction about a rotation axis of the rotor core between the end of the first magnetic pole surface on the first circumferential side and the end of the second magnetic pole surface on the second circumferential side is an angle within a range of 128°±10° in terms of an electrical angle, and
an angle formed in the circumferential direction about the rotation axis between an end of the first magnetic pole surface on the first circumferential side at a part that does not overlap the first hole as viewed in the radial direction and an end of the second magnetic pole surface on the second circumferential side at a part that does not overlap the second hole as viewed in the radial direction is an angle within a range of 104°±10° in terms of the electrical angle.

5. The rotor according to claim 1, wherein
the first permanent magnet is inserted into a first magnet insertion hole formed in the rotor core so as to extend in an axial direction,
the second permanent magnet is inserted into a second magnet insertion hole formed in the rotor core so as to extend in the axial direction,
the first hole is formed integrally with the first magnet insertion hole so as to communicate with the first magnet insertion hole, and
the second hole is formed integrally with the second magnet insertion hole so as to communicate with the second magnet insertion hole.

6. The rotor according to claim 1, wherein each of an inner surface of the first hole on the outer side in the radial direction and an inner surface of the second hole on the outer side in the radial direction has a part parallel to the outer peripheral surface of the rotor core.

7. A method for designing a rotor for an inner rotor rotating electrical machine, including a rotor core and permanent magnets embedded in the rotor core, wherein
magnetic poles are each formed by a pair of the permanent magnets arranged side by side in a circumferential direction,
of the pair of the permanent magnets that form one of the magnetic poles, the permanent magnet arranged on a first circumferential side that is one side in the circumferential direction is defined as a first permanent magnet, and the permanent magnet arranged on a second circumferential side that is the other side in the circumferential direction is defined as a second permanent magnet, the method comprising:
arranging a first magnetic pole surface that is a magnetic pole surface of the first permanent magnet that is oriented toward an outer side in a radial direction so that a portion of the first magnetic pole surface that is closer to the first circumferential side is located further outward in the radial direction; and
arranging a second magnetic pole surface that is a magnetic pole surface of the second permanent magnet that is oriented toward the outer side in the radial direction so that a portion of the second magnetic pole surface that is closer to the second circumferential side is located further outward in the radial direction, wherein:
the rotor core includes a first hole formed on the outer side in the radial direction with respect to the first magnetic pole surface at a position where the first hole overlaps, as viewed in the radial direction, a first end region including an end of the first magnetic pole surface on the first circumferential side, and a second hole formed on the outer side in the radial direction with respect to the second magnetic pole surface at a position where the second hole overlaps, as viewed in the radial direction, a second end region including an end of the second magnetic pole surface on the second circumferential side, and
the first hole and the second hole are formed so that harmonic components of a plurality of target orders on a fundamental component of a counter-electromotive voltage generated by rotation of the rotor on a coil of a stator arranged so as to face an outer peripheral surface of the rotor core are reduced as compared to a case where the first hole and the second hole are not provided.

8. The method for designing a rotor according to claim 7, wherein the first hole and the second hole are formed so that an angle formed in the circumferential direction about the rotation axis between an end of the first magnetic pole surface on the first circumferential side at a part that does not overlap the first hole as viewed in the radial direction and an end of the second magnetic pole surface on the second circumferential side at a part that does not overlap the second hole as viewed in the radial direction corresponds to an electrical angle at which the harmonic components of the plurality of target orders on the fundamental component of the counter-electromotive voltage are reduced together.

9. The method for designing a rotor according to claim 7, wherein
an angle formed in the circumferential direction about the rotation axis of the rotor core between the end of the first magnetic pole surface on the first circumferential side and the end of the second magnetic pole surface on the second circumferential side is set to an angle within a range of 128°±10° in terms of the electrical angle, and
the angle formed in the circumferential direction about the rotation axis between the end of the first magnetic pole surface on the first circumferential side at the part that does not overlap the first hole as viewed in the radial direction and the end of the second magnetic pole surface on the second circumferential side at the part that does not overlap the second hole as viewed in the radial direction is set to an angle within a range of 104°±10° in terms of the electrical angle.
